(19) United States
(12) Patent Application Publication
(10) Pub. No.: US 2025/0321898 A1
(43) Pub. Date: Oct. 16, 2025

(54) ENHANCED REGION TAGGING

(71) Applicant: QUALCOMM Incorporated, San Diego, CA (US)

(72) Inventors: David HARTLEY, Berlin (DE); Jeremy Robin Christopher O'DONOGHUE, Wokingham (GB)

(21) Appl. No.: 19/065,649

(22) Filed: Feb. 27, 2025

Related U.S. Application Data
(60) Provisional application No. 63/634,305, filed on Apr. 15, 2024.
(60) Provisional application No. 63/634,319, filed on Apr. 15, 2024.
(60) Provisional application No. 63/634,318, filed on Apr. 15, 2024.
(60) Provisional application No. 63/634,300, filed on Apr. 15, 2024.

(51) Int. Cl. G06F 12/1027

(52) U.S. Cl. CPC G06F 12/1027

(57) ABSTRACT

Certain aspects provide a method for processing a transaction. The method generally includes obtaining a transaction indicating a virtual address (VA), and an identifier (ID) for a security state of the transaction initiator, selecting a translation regime based on the ID, determining a physical address (PA) and a PA space (PAS) based on the selected translation regime and the VA, and processing the transaction based on the PA and the PAS.

### CROSS-REFERENCE TO RELATED APPLICATION

This application claims benefit of and priority to U.S. Provisional Patent Application Nos. 63/634,300, 63/634,305, 63/634,318, and 63/634,319, all filed Apr. 15, 2024 and hereby incorporated by reference in their entirety.

### BACKGROUND

### Field of the Disclosure

Aspects of the present disclosure relate to techniques for memory management and shared access in a computing environment.

### Description of Related Art

Partitioning operations of a processor in computing systems may be performed to achieve security, isolation, and controlled execution environments. This can be implemented using several mechanisms, primarily for purposes such as security, virtualization, and fault tolerance.

The partitioning may ensure that different processes or applications running on the processor are isolated from one another, which may be vital for security reasons. For example, if one process is compromised (e.g., through a buffer overflow or malware), it should not be able to access or manipulate other processes' data, or underlying hardware.

The partitioning may help contain faults to a specific domain or process, preventing them from spreading across an entire system. For example, if a particular process or virtual machine crashes, the rest of the system remains unaffected. This is especially important for systems where uptime and reliability are critical, such as real-time applications.

The partitioning may ensure that the processor and other resources are allocated effectively and fairly among different tasks or users. For example, in cloud hosting, a hypervisor allocates processor resources to different virtual machines running on a same physical server, ensuring fair performance and preventing one virtual machine from consuming all the resources.

Virtualization involves creating multiple virtual machines on a single physical processor, where each virtual machine operates in its own isolated environment. This partitioning is managed by a layer called a hypervisor. The hypervisor sits between a physical hardware and the virtual machines, ensuring that each virtual machine gets its own allocation of the processor, memory, and storage, while isolating them from each other. Virtual machine are unable to interfere with one another directly, even if they are running on the same physical machine. This creates mutually distrustful environments, as each virtual machine believes it has its own dedicated hardware. In typical virtualization architectures, the virtual machines are not isolated from the hypervisor. For some security/privacy use cases such as confidential computing it is beneficial to have some virtual machines running on the same processor that are isolated and protected from the hypervisor, creating a further level of security domain called a world in some processor architectures. Virtual machines that are not isolated from the hypervisor are in the “normal” world while isolated virtual machines run in another world.

Memory protection mechanisms enforce boundaries between different parts of a memory associated with the processor, ensuring that one program cannot access or corrupt the memory of another program or the kernel. A memory management unit (MMU) in the processor translates virtual addresses to physical addresses and ensures that programs running in user mode cannot directly access memory allocated to other programs or the kernel. One or more memory isolation techniques help partition execution into independent, mutually distrusting domains.

### SUMMARY

One aspect provides a method for processing a transaction, by a memory management unit (MMU). The method includes obtaining a transaction indicating a virtual address (VA) and an identifier (ID) for a security state of an initiator of the transaction; selecting a translation regime based on the ID; determining a physical address (PA) and a PA space (PAS) based on the selected translation regime and the VA; and processing the transaction based on the PA and the PAS.

Other aspects provide: an apparatus operable, configured, or otherwise adapted to perform the aforementioned method as well as those described elsewhere herein; a non-transitory, computer-readable media comprising instructions that, when executed by one or more processors of an apparatus, cause the apparatus to perform the aforementioned method as well as those described elsewhere herein; a computer program product embodied on a computer-readable storage medium comprising code for performing the aforementioned method as well as those described elsewhere herein; and an apparatus comprising means for performing the aforementioned method as well as those described elsewhere herein. By way of example, an apparatus may comprise a processing system, a device with a processing system, or processing systems cooperating over one or more networks.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example computing environment with a memory management unit (MMU) and translation lookaside buffer (TLB) according to various aspects of the present disclosure.

FIG. 2 illustrates example of a system memory management unit (SMMU) and TLB according to various aspects of the present disclosure.

FIG. 3 illustrates a system for managing partitioning and allocation of memory regions associated with one or more processors according to various aspects of the present disclosure.

FIG. 4 illustrates an example enhancement mapping of virtual address (VA) to physical address (PA) and memory regions according to various aspects of the present disclosure.

FIG. 5 illustrates example operations for enhanced region tagging according to various aspects of the present disclosure.

FIG. 6 illustrates example operations for supporting mixed criticality operations according to various aspects of the present disclosure.

FIG. 7 illustrates an example method according to various aspects of the present disclosure.

FIG. 8 illustrates an example method according to various aspects of the present disclosure.

FIG. 9 depicts aspects of an example device according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

A memory management unit (MMU) generally refers to a hardware component in a processor responsible for performing address translation from virtual addresses to physical addresses. The MMU plays a critical role in computing systems by enabling efficient memory usage, process isolation, and device and memory protection. The MMU ensures that a process cannot access address ranges allocated exclusively to other processes or the operating system. The MMU facilitates memory sharing between processes while ensuring isolation to prevent unintended disclosure or interference. In a processor that supports virtualization, the MMU ensures that a process or operating system in one VM cannot access address ranges allocated exclusively allocated to other VMs or the hypervisor. The MMU may include a translation lookaside buffer (TLB), page tables, and/or access control logic. The TLB is a specialized cache within the MMU that stores recent address translations. The page tables are data structures maintained by an operating system and a hypervisor that map the virtual addresses to the physical addresses. The MMU consults these tables during address translation. The access control logic verifies access permissions (e.g., whether a process can read, write, or execute a specific address range).

A system MMU (SMMU), also known as an input/output MMU (IOMMU), generally refers a specialized hardware component used in system on chips (SoCs) and computing platforms. The SMMU is designed to manage access and translation specifically for devices like network adapters, and other hardware accelerators that need to access physical address ranges. The SMMU serves a role similar to the MMU, but it operates for peripheral devices instead of the processor. The SMMU enforces access control for devices, ensuring they read or write only to allowed address ranges. The SMMU allows virtual machines to use devices without direct intervention from a hypervisor by providing address translation and isolation for those devices. Multiple devices and virtual machines may share a single SMMU, which selects the corresponding page tables based on identifiers that accompany each incoming transaction, such as a StreamID (SID), that indicate a set of transactions called a transaction stream, with common access policies and translation regimes

In the context of secure processing, a world, also known as a supervisor domain or secure arbitration mode, may refer to a separate security state providing an isolated execution environment within a processor. A world may be designed to protect processing of sensitive data with sensitive code by preventing unintended access or interference from existing processes, operating systems, virtual machines and the hypervisor, which may be known collectively as the “normal” world. Different processor architectures may support one or more worlds; at least two worlds are required to provide confidential computing capabilities. Like the normal world, other worlds may themselves be partitioned into isolated execution environments hosting virtual machines and possibly a hypervisor. In some processor architectures, all worlds are equivalent and there is no distinguished “normal” world.

In the context of secure processing, the physical address space (PAS) may be partitioned between processor worlds. An MMU or SMMU may support worlds by providing isolation mechanisms designed to ensure that processes and devices are allowed to access only the physical address (PA) ranges assigned to them. The PA ranges assigned to a world may be referred to as the world PAS. The MMU or SMMU may also facilitate memory sharing between worlds while ensuring isolation to prevent unintended disclosure or interference. In some cases, this isolation may be accomplished by performing a check of physical addresses, after virtual address (VA) to physical address (PA) translation, to ensure a process or device in a given world is allowed to access a given PA range. If the check fails, meaning a particular PA range is not allowed for a given world PAS, a process or device seeking access may be denied and a fault may be created.

Aspects of the present disclosure provide various mechanisms that may help enhance the support of additional worlds (called SoC worlds) and related workloads associated with devices and execution environments supplemental to the available processor security states.

According to certain aspects, an enhanced region tagging mechanism is provided. The mechanisms proposed herein may enable selectable translation for SoC world transactions. In the enhanced region tagging mechanism proposed herein a (VA to PA) translation regime for a transaction may be based on and managed by a SoC world from which a transaction is issued.

According to certain aspects, mixed criticality (transaction streams accessing PA ranges shared between worlds with different levels of criticality) may be supported using configurable access and translation regimes. To support mixed criticality, a translation regime for a SoC world may be selected to be managed by another world, such as the normal world. In addition, a type of access (e.g., read or write) to a PA range shared with the other world may be allowed or denied based on the SID and SoC world from which a transaction is issued. According to certain aspects, a memory management unit (MMU) may be configured for an SoC world to support mixed criticality or not. Further, various use cases may be supported via enhanced choices for page table management and access permissions.

### Example System-On-a-Chip (SoC)

System-on-a-chip (SoC) devices may include one or more central or application processors, one or more interconnects (or buses), one or more peripheral devices (or upstream devices), and one or more slave devices. The SoC devices may further include a memory management unit (MMU) coupled to a processor and one or more system MMUs (SMMUs) coupled to the one or more peripheral devices.

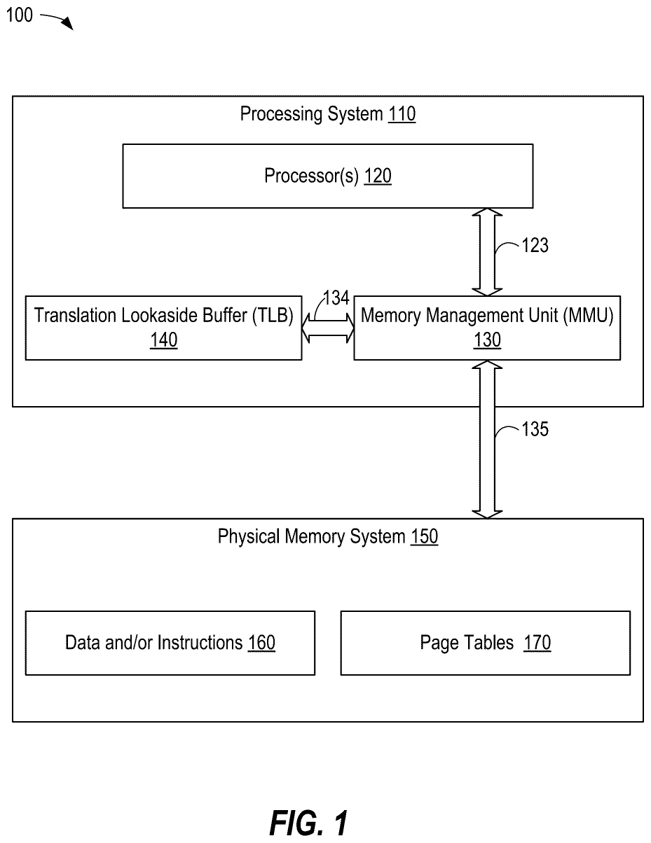

FIG. 1 illustrates an example computing environment 100 according to various aspects of the present disclosure. The computing environment 100 includes a processing system 110, which represents a physical computing device or a virtual computing device that runs a on a physical computing device. Processing system 110 includes one or more processors 120, which may represent central processing units (CPUs) and/or other processing devices configured to execute instructions to perform various computing operations. As used herein, the terms processor and CPU may be used interchangeably and may refer to a same entity.

A processor interconnect 123 may couple the processor(s) 120 to a MMU 130 of the processing system 110. The MMU 130 may perform translation of virtual memory addresses into physical memory addresses. The MMU 130 may be coupled to a TLB 140 of the processing system 110 via a TLB path 134. The TLB 140 may include mappings of virtual memory addresses to physical memory addresses that have been cached.

The computing environment 100 further includes a physical memory system 150, which may include data and/or instructions 160 and page tables 170. The physical memory system 150 may be, for example a random access memory (RAM). The MMU 130 may be coupled to the physical memory system 150 via a physical memory interconnect 135.

The page tables 170 map each virtual address used by the processing system 110 to a corresponding physical address associated with the physical memory system 150. The physical address may be located in the physical memory system 150, a hard drive (not shown), or some other storage component. When the processing system 110 needs to access (e.g., read or write) data, the processor(s) 120 may send the virtual address of the requested data to the MMU 130. The MMU 130 may perform the translation in tandem with the TLB 140 and/or physical memory system 150 and then return the corresponding physical address to the processor(s) 120.

To perform the translation, the MMU 130 first checks the TLB 140 to determine if the virtual address of the requested data matches a virtual address associated with one of the TLB 140 entries. If there is a match between the requested virtual address and a virtual address in a particular TLB 140 entry, the processing system checks the TLB 140 entry to determine whether the valid bit is set. If the entry is valid, then the TLB 140 entry includes a valid translation of the virtual address. Accordingly, a corresponding physical address can be returned very quickly to the MMU 130, thereby completing the translation. Using the translated physical address, the processing system 110 can access the requested data.

If the MMU 130 determines that the virtual address of the requested data does not match a virtual address associated with one of the TLB 140 entries (or if a matching TLB 140 entry is marked as invalid), then the MMU 130 walks through the page tables 170 in the physical memory system 150 until a matching virtual address is found.

Each translation may be performed in levels. For example, the MMU 130 may walk through a first page table of the page tables 170 in search of a match. A matching entry found in the first page table may include the first several bits of a physical address and an indication that additional bits may be found in a second page table of the page tables 170. The MMU 130 may then store the first several bits and walk through the second page table in search of a match. As noted above, the matching entry may include the next several bits of the physical address, and the process repeats if the matching entry includes an indication that additional bits may be found in a third page table of the page tables 170. The process may repeat until the matching entry indicates that a last level of translation has been reached. The last level may be, for example, the level that was most-recently reached. Once the last level of translation has been completed, the MMU 130 should have a complete translation of the full physical address.

If there is a match between the requested virtual address and a virtual address in a particular page table entry, the processing system 110 retrieves a physical address from the page table entry. Once found, the physical address is returned to the MMU 130. However, using the page tables 170 to perform the translation may be much slower than using the TLB 140. The TLB 140 is smaller than the physical memory system 150 and less remote than the physical memory system 150. Accordingly, the TLB 140 may be searched more quickly. The TLB 140 typically replicates a subset of the translations located in the page tables 170. The replicated translations are generally associated with virtual addresses that are most important, most frequently-used, and/or most recently-used.

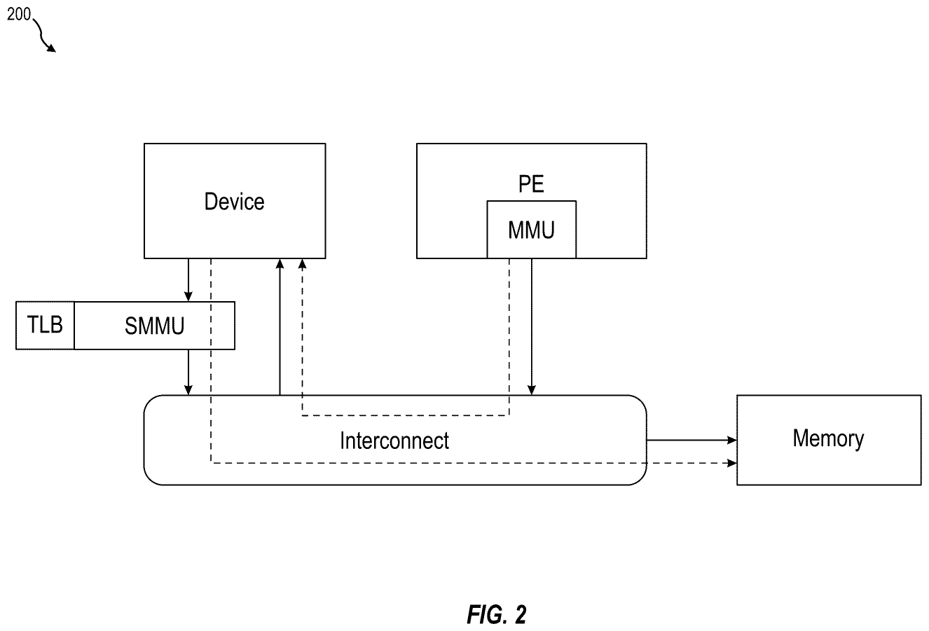

FIG. 2 is an illustration 200 of an example of a SMMU according to various aspects of the present disclosure. The SMMU performs a task that may be considered analogous to that of a MMU (e.g., the MMU 130 of FIG. 1) in a processing element (PE). For example, the SMMU may translate addresses for direct memory access (DMA) requests from a system input/output (I/O) device before the DMA requests are passed into a system interconnect. The SMMU may be active for DMA only. The translation of the DMA addresses may be performed for reasons of isolation or convenience.

The SMMU may only provide translation services for transactions from the device, and not for transactions to the device. For example, traffic (or transactions) in the other direction, that is, from a processing system to the device may be managed by other means such as a processing system MMU.

In some aspects, in order to associate device traffic with translations and to differentiate different devices behind the SMMU, the DMA requests may have extra information, alongside address and access type (read/write). For example, this extra information may include a StreamID (SID). As described above, an SID may indicates a set of transactions called a transaction stream, with common access policies and translation regimes. Different streams may be logically associated with different devices, device states or data types and the SMMU may perform different translations or checks for each stream.

In some aspects, a number of SMMUs may exist within a system. Each SMMU may translate traffic from one device or a set of devices.

The SMMU may support two stages of translation in a similar way to PEs supporting virtualization extensions. Each stage of translation may be independently enabled. An incoming address may be logically translated from a virtual address (VA) to an intermediate physical address (IPA) in stage 1, then the IPA is input to stage 2 which translates the IPA to an output physical address (PA). Stage 1 is intended to be used by a software entity to provide isolation or translation to buffers within an entity. Stage 2 is intended to be available in systems supporting the virtualization extensions and is intended to virtualize device DMA to guest virtual machine (VM) address spaces. When both stage 1 and stage 2 are enabled, the translation configuration is called nested.

The SMMU may have three interfaces that software uses. For example, the SMMU may include memory-based data structures that may be used to map devices to translation tables that are used to translate device addresses. The SMMU may include memory-based circular buffer queues such as a command queue for commands to the SMMU and an event queue for event/fault reports from the SMMU. The SMMU may include a set of registers, some of which are secure-only, for discovery and SMMU-global configuration. The registers indicate base addresses of the structures and queues, provide feature detection and identification registers and a global control register to enable queue processing and translation of traffic.

In some aspects, an incoming transaction may have an address, size, and attributes such as read/write, secure/non-secure, share ability, and cache ability. If more than one device or a device shared by more than one VM or more than one World uses the SMMU, the traffic may also have a World ID and a Stream ID so the sources can be differentiated. Incoming transactions with the same World ID and Stream ID are initiated by the same device and share the same access and translation regimes.

### Example Partitioning of Memory for Secure Processing

Aspects of the present disclosure provide apparatuses, methods, processing systems, and computer-readable mediums for managing partitioning and allocation of memory regions (e.g., address spaces) associated with one or more processors for different tasks.

One or more mechanisms may be used for partitioning operations of a processor (e.g., a central processing unit) into mutually distrusting domains (e.g., processing domains or worlds). The mutually distrusting domains associated with the processor may refer to separate execution environments or contexts within the processor (or a system) that are isolated from each other due to security, privacy, and/or integrity concerns. The mutually distrusting domains associated with the processor do not trust each other, meaning that they operate under the assumption that other domains may attempt to compromise their security or integrity. The operations of the processor may be partitioned into the mutually distrusting domains to protect confidentiality of resources in the different domains associated with the processor.

The different mechanisms for partitioning the operations of the processor into the mutually distrusting domains may include a confidential virtual machine environment (CoVE) mechanism, a confidential compute architecture (CCA) mechanism, a trust domain extension (TDX) mechanism, etc. Such mechanisms may be designed with a focus on confidentiality and security of data, and to provide strong isolation for workloads running in virtual machines. Such mechanisms may help establish trusted execution environments or trust domains within a system.

In some distributed computing systems, software or hardware creates an abstraction of a shared memory space across physically separate processors. This allows processors to lend parts of their memory space to others indirectly by making it accessible across the network.

In some systems, a processor may be able to donate resources (e.g., in a physical address space) under its control to an off-processor entity (e.g., another processor) such that operations of the off-processor entity may be kept confidential from a donor processor (i.e., the processor which donates the resources under its control to the off-processor entity). The physical address space refers to an actual range of addresses that a computer's physical memory can access. It represents the hardware's view of memory locations and is determined by the system's memory architecture and the number of address lines on the processor.

In some systems, one or more confidential processing domains or worlds under the processor control may coexist with more than one confidential processing domain or world controlled by more than one off-processor entity.

In some systems, a stage 3 checker (e.g., based on walking page tables) may be used to verify that stage 1 and 2 memory translations from a memory management unit (MMU)/system memory management unit (SMMU) in different processing domains or worlds associated with the processor (e.g., which may be under control of untrusted hypervisors) are valid. The stage 1 translation may translate virtual addresses used by a software (e.g., a process or virtual machine) into intermediate physical addresses. The stage 2 translation may translate the intermediate physical addresses (from stage 1) into the actual physical addresses used by a hardware. In memory system designs, a stage 3 checker may be a final stage in a series of validation steps (e.g., checking translation correctness after stage 1 and stage 2 translations in a virtualized system).

In some systems, a trusted off-processor entity (e.g., such as a system on a chip (SoC) world controller) that may control programming of stage 3 tables (e.g., preventing interference with the stage 3 tables by the processor) may assist. For example, if the trusted off-processor entity may be provided with multiple interfaces, the trusted off-processor entity may operate a memory partitioning protocol allowing co-operation between multiple distrusting domains or actors associated with the trusted off-processor entity.

In some systems, it may be costly in terms of a memory to have all mutually untrusting domains in a system mapped into worlds as this may make required tables unreasonably large, and it might then be desirable to use the stage 3 checker in conjunction with slave-side memory protection units which sub-partition a physical memory allocated to some or all domains. In some cases, placing the memory protection units under control of the SoC world controller may allow for enhanced memory management protocols.

Techniques described herein define a trusted off-processor entity that may manage or control domains separation for a processor. The trusted off-processor entity may act as a relay to manage or control physical address (or memory) partitioning provided by xPUs. An xPU may refer to a memory protection unit (MPU, where x=M), register protection unit (RPU, where x=R) or address protection unit (APU, where x=A). The techniques described herein may allow to sub-partition off processor resources (e.g., such as memory resources) provided by the processor at a lower cost than instantiating additional SMMU components.

One or more hardware devices used to implement the techniques described herein may be managed using a memory management protocol, which may be enhanced with knowledge of SoC sub-domains. One approach may be to enhance or extend a memory protocol to the hardware devices to be SoC sub-domain aware.

The sub-partitioning of processor managed domains or worlds may be performed a low hardware cost. Also, the hardware devices may be easy to integrate with existing systems. These improvements are particularly advantageous in contexts where computing resources are limited and/or where memory management performance is key, such as in the context of mobile devices, machine learning, and/or the like.

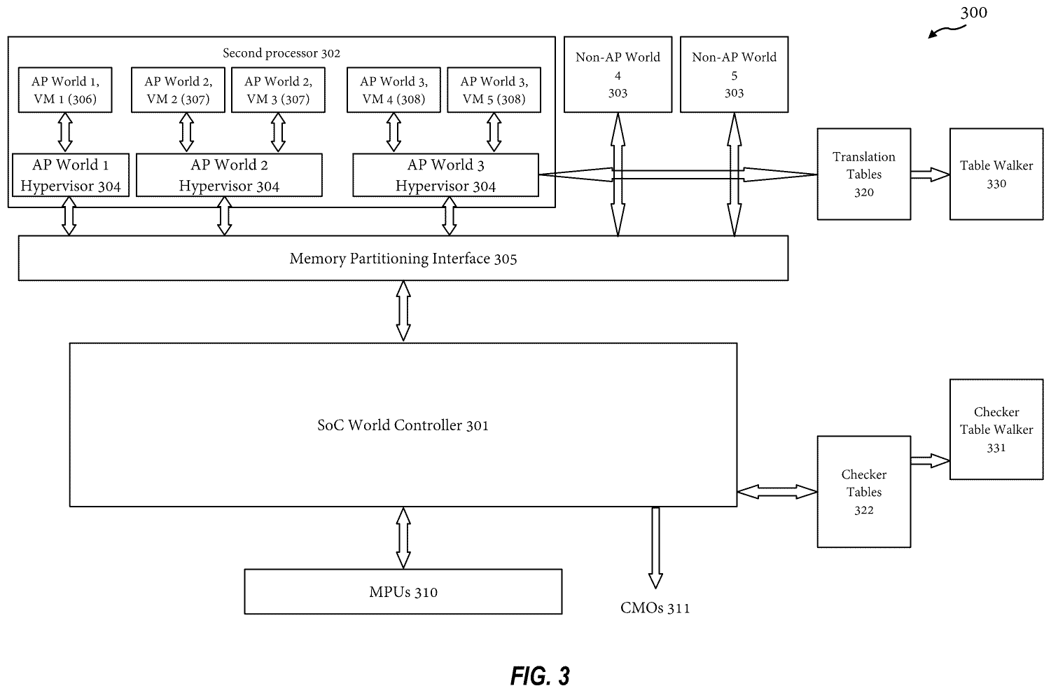

FIG. 3 illustrates a system 300 for managing partitioning and allocation of memory regions associated with one or more processors. The system 300 may include a SoC world controller 301 (e.g., which may be or is associated with a first processor), multiple endpoints (e.g., devices) associated with a second processor 302 (e.g., such as a main processor), and memory protection units (MPUs) 310. The SoC world controller 301 may be associated with the MPUs 310. The SoC world controller 301 may be capable of issuing cache management operations (CMOs) 311 to any of the second, third or subsequent processors. The SoC world controller 301 may be associated with the multiple endpoints 306, 307, 308 and multiple hypervisors 304 associated with the second processor 302 or endpoints associated with third and subsequent processors 303.

The SoC world controller 301 may further be associated with translation tables 320, protection checker tables 322, a translation table walker 330 and/or a checker table walker 331.

The checker tables 322 provide mechanisms for partitioning the address space of the system 300 into multiple regions that are accessible to one or more worlds. The checker tables 322 holds data structures in a memory that are used to manage and enforce memory protection at the granularity of memory granules (e.g., fixed-size blocks of the memory), allowing fine-grained control over memory access. The checker table walker 331 is a hardware or software mechanism responsible for traversing the data structures in the checker tables 322 to resolve access permissions and attributes for memory regions. It is part of a MMU in systems that use the checker tables 322 to enforce physical memory access control.

The translation table walker 330 may be a component of an MMU-based memory management system in modern processors. The translation table walker 330 traverses the translation tables 320 to resolve memory addresses and enforce access permissions for virtual memory and virtualization systems. The translation tables 320 may be configured by a hypervisor 304. As already described for the translation tables 320, the checker tables 322 may also be hierarchical data structures decomposed into two or more levels for efficiency of storage and traversal.

The SoC world controller 301 may be associated with and implement a memory partitioning interface (or a memory partitioning mechanism) 305. The memory partitioning mechanism 305 of the SoC world controller 301 may perform partitioning of a physical address space or a memory associated with the second processor 302 to create mutually untrusting memory regions. The mutually untrusting memory regions on the second processor 302 may be called worlds 306, 307, 308 (e.g., which may be enforced by MMU/SMMU checking tables (e.g., granule protection tables, memory tracking table for supervisor domain isolation)). An MMU/SMMU may support separate translation tables and hypervisors for each world.

The SoC world controller 301 may receive partitioning information for partitioning the memory associated with the second processor 302 into the mutually untrusting memory regions from one or more mechanisms, that may partition the memory associated with the second processor 302 based on a physical address, such as the MPUs 310. The MPU 310 may be a hardware component in a processor designed to enforce access restrictions to different regions of the memory. The MPU 310 may ensure that only authorized processes or programs can access specific areas of memory, enhancing security, stability, and reliability in embedded and real-time systems.

The SoC world controller 301 may receive partitioning information for partitioning the memory associated with the second processor 302 into the mutually untrusting memory regions from one or more mechanisms, that may partition the memory associated with the second processor 302 based on both translation and physical address, such as the MMU.

The SoC world controller 301 may allocate partitioned memory regions associated with the second processor 302 to different endpoints 306, 307, 308 or other processors. For example, an endpoint may be allocated one or more memory regions or worlds associated with the a third or subsequent processor.

In certain aspects, the SoC world controller 301 may perform permanent transfer operations corresponding to the partitioned memory regions associated with the second processor 302. For instance, the memory partitioning mechanism 305 may transfer ownership of a memory region associated with the second processor 302 from one virtual machine endpoint to another virtual machine endpoint within the same world.

In one example, the memory partitioning mechanism 305 may transfer the ownership of the one or more memory regions associated with the second processor 302 allocated for a first processing domain (e.g., application processor (AP) world 2, virtual machine (VM) 2 (307)) associated with the second processor 302 to a second processing domain (e.g., AP world 1, VM 1 (306)) associated with the second processor.

In another example, the memory partitioning mechanism 305 may transfer the ownership of the one or more memory regions associated with the second processor 302 allocated for a donator endpoint (e.g., AP world 2, VM 3 (307)) to a receiver endpoint (e.g., a non-AP world 4 or 5 (303)).

In certain aspects, the SoC world controller 301 may perform lending operations corresponding to the partitioned memory regions associated with the second processor 302. For instance, the memory partitioning mechanism 305 may transfer access rights to a memory region to one or more borrower endpoints without relinquishing ownership but explicitly relinquishing access rights.

In one example, the memory partitioning mechanism 305 may transfer access rights of the one or more memory regions associated with the second processor 302 allocated for the first processing domain associated with the second processor 302 to the second processing domain associated with the second processor 302.

In another example, the memory partitioning mechanism 305 may transfer access rights of the one or more memory regions associated with the second processor 302 allocated for a lender endpoint to a borrower endpoint.

In certain aspects, the SoC world controller 301 may perform share operations corresponding to the partitioned memory regions associated with the second processor 302, to enable access by more than one endpoint. For instance, the memory partitioning mechanism 305 may transfer access rights to a memory region to one or more borrower endpoints while retaining ownership and access rights.

In one example, the memory partitioning mechanism 305 may temporarily share access rights of the one or more memory regions associated with the second processor 302 allocated for the first processing domain associated with the second processor 302 with the second processing domain associated with the second processor 302 for a threshold period.

In another example, the memory partitioning mechanism 305 may temporarily share access rights of the one or more memory regions associated with the second processor 302 allocated for a lender endpoint with a receiver endpoint on a third or subsequent processor for a threshold period.

In certain aspects, the SoC world controller 301 may perform reclaim operations corresponding to the partitioned memory regions associated with the second processor 302. For instance, an owner of a memory region may request that one or more borrower endpoints may relinquish their access rights to a memory region so that the owner can reclaim access.

In one example, the owner of the memory region may request the second processing domain associated with the second processor 302 to relinquish the access rights of the memory region. The owner of the memory region may receive a notification from the second processing domain associated with the second processor 302 that the second processing domain has relinquished the access rights of the memory region.

In another example, the owner of the memory region may request the borrower endpoint on the third or subsequent processor to relinquish the access rights of the memory region. The owner of the memory region may receive a notification from the borrower endpoint that the borrower endpoint has relinquished the access rights of the memory region.

### Example Enhanced Region Tagging

As noted above, a world, also known as a supervisor domain or secure arbitration mode, may refer to a separate security state providing an isolated execution environment within a processor. A world may be designed to protect processing of sensitive data with sensitive code by preventing unintended access or interference from existing processes, operating systems, virtual machines and the hypervisor, which may be known collectively as the “normal” world. Different processor architectures may support one or more worlds; at least two worlds are required to provide confidential computing capabilities. Like the normal world, other worlds may themselves be partitioned into isolated execution environments hosting virtual machines and possibly a hypervisor. In some processor architectures, all worlds are equivalent and there is no distinguished “normal” world.

Aspects of the present disclosure provide various mechanisms that may help enhance the support of additional worlds (called SoC worlds) and related workloads associated with devices and execution environments supplemental to the available processor security states. According to certain aspects, an enhanced region tagging mechanism is provided. In the enhanced region tagging mechanism proposed herein a (VA to PA) translation regime for a transaction may be based on and managed by a SoC world from which a transaction is issued.

According to certain aspects, mixed criticality (e.g., transaction streams accessing PA ranges shared between worlds with different levels of criticality) may be supported using configurable access and translation regimes. To support mixed criticality, a translation regime for a SoC world may be selected to be managed by another world, such as the normal world. In addition, a type of access (e.g., read or write) to a PA range shared with the other world may be allowed or denied based on the SID and SoC world from which a transaction is issued.

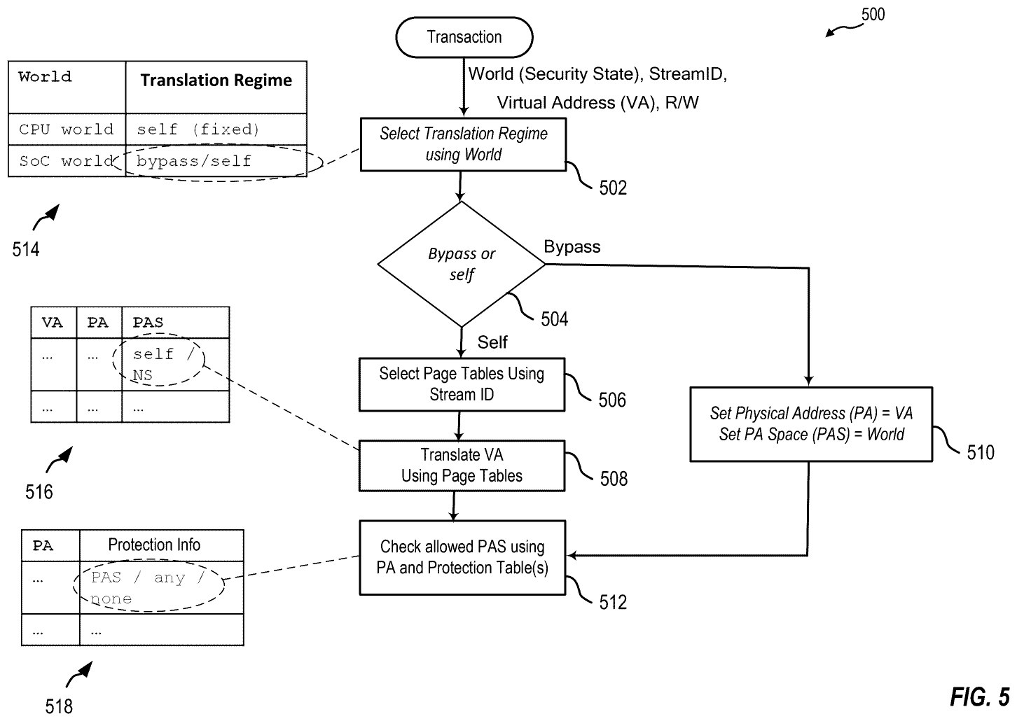

The techniques propose herein may help support multiple (CPU and SoC) worlds and allow various MMUs (e.g., an MMU/SMMU) to efficiently perform various translations and protection checks, as will be described in greater detail below with reference to FIG. 5.

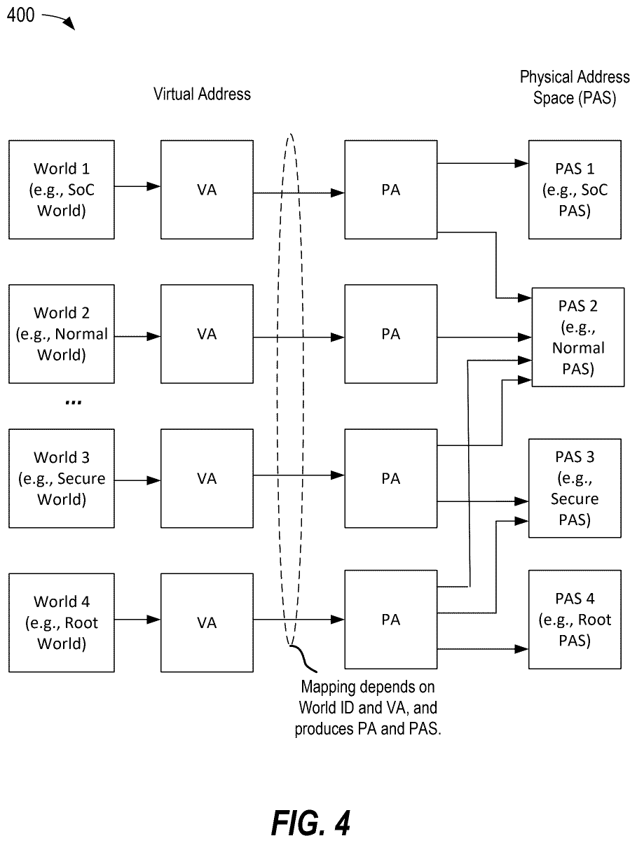

Diagram 400 of FIG. 4 illustrates an example mapping of VAs to PAs and physical address spaces (PASs) associated with different worlds. For illustrative purposes, four worlds (SoC world 1 and CPU worlds 2-4) are shown in the example illustrated in FIG. 4.

As illustrated, there may be multiple PASs, corresponding to different worlds. In the illustrated example, these PASs include a SoC PAS, a normal PAS, a Secure PAS, and a Root PAS.

As illustrated, which PA space (or spaces) a virtual address can be mapped to depends on the current world of a corresponding processing element (PE) or device. In the example shown in FIG. 4, for normal world, virtual addresses may only map to normal PAS. For secure world, virtual addresses may map to Secure PAS or normal PAS. For SoC world, virtual addresses may map to SoC PAS or Normal PAS. For Root world, virtual addresses may map to any processor PAS. When a PE or device is in a world that can access multiple PASs, translation table entries may control which PAS is used.

Mechanisms proposed herein may help enhance translation options for SoC worlds.

The mechanisms may be understood with reference to the flow diagram 500 of FIG. 5, that shows one example of how to process a transaction which is targeted for some PA range.

As illustrated, the transaction may contain (or otherwise indicate) various identifiers (e.g., as signals on the bus). Such information may include an identifier for the world which is usually called World ID (which may be referred to as a Security State ID). The identifiers may also include a stream ID, a virtual address (VA), and whether the transaction is a read or a write transaction. Other information may also be included.

Certain worlds may be considered CPU worlds while other worlds are considered SoC worlds. CPU worlds may include non-secure (NS), secure, realm, and root worlds. Other worlds may be considered SoC worlds, which may include any number of implementation defined SoC worlds. Mechanisms proposed herein may help support a number of such additional worlds. In some cases, such worlds may be identified via one or more bits

As illustrated at 502 in FIG. 5, a particular translation regime (or translation mode) may be selecting using the world that was supplied by the device (that issued the transaction).

For transactions issued from a CPU world, for example, existing SMMU mechanisms may require translation to be managed by the same CPU world, just as for the MMU. For transactions issued from a SoC world, existing SMMU mechanisms may require translation to be bypassed. With the enhanced SMMU mechanism proposed here the translation regime may be selected from a table 514 using the world ID (e.g., either CPU world or SoC world).

The ability to select a translation regime in this manner may have advantages over a scheme in which the translation regime is fixed (e.g., a fixed bypass regime or a fixed self-translation regime).

With a fixed bypass regime for SoC worlds, a product that needs to partition or virtualize a SoC world's PAS has to implement a separate MMU/SMMU for that purpose. The additional option of SMMU translation saves the extra MMU/SMMU in such products.

On the other hand, a fixed self-translation regime for SoC worlds would require products with no need to partition/virtualize the PAS to add software in the SoC World Controller that configures the self-translation regime for bypass.

The ability to select a translation regime and retain the bypass regime option for SoC worlds, as proposed herein, may help avoid the need for additional software in such products.

In the example illustrated in FIG. 5, the possible translation modes include a self-translation mode, and a bypass translation mode. For example, looking up a table for one of the CPU worlds, the translation mode would be the self-translation mode.

The self-translation mode may mean that the world itself (that issued the transaction) will do the translation itself. In other words, the translation may be done in the same world as the device transaction (the world has a translation regime of its own). As illustrated, this may be the only option for a CPU world (e.g., may be fixed in hardware rather than updatable by writing to the table).

As illustrated, for an SoC world, there may be a number of different translation modes. In this case, the translation mode may be self, or bypass. As indicated, if a self translation mode is selected, as determined at 504, a page table based translation is performed. In some cases, in the self translation regime, the managing world has the choice to bypass one or both stages of translation. In the bypass translation regime enforced for SoC worlds in existing SMMUs, there may be no choice but to bypass translation.

As illustrated, one or more page tables may be selected (at 506) using the stream ID. The VA may be translated to a PA, using page table 508. As illustrated, table 508 may include an additional output, which is a PAS. As illustrated, the PAS may be a self (e.g., corresponding to the world that issued the transaction) or another PAS such as the NS PAS.

As indicated, if the bypass translation mode is selected, as determined at 504, page table based translation may be bypassed. In this case, as illustrated at 510, the PA may be set to be the same as the VA and the PAS may be set to the PAS corresponding to the world.

As illustrated at 512, a check may be performed of allowed PAS using the PA and one or more protection tables. For example, the PA may be used to look up protection information from a table 518, which may be referred to as a protection table or a granular protection table (GPT so called as it applies to a granular amount of memory).

The check performed may involve comparing the PAS obtained from table 518 to the PAS from table 516. This check may indicate whether the PAS obtained from table 516 is allowed for the PA. If the check fails, an exception (or fault) may be declared, and the desired memory access via the transaction may be denied.

In this manner, protection tables may be updated and used to control access for various worlds. This updating of a protection table (e.g., a GPT) may be performed, for example, by an SoC World controller (described above with reference to FIG. 3). In some cases, a GPT may be held in Root memory to ensure that it is isolated from all other worlds (and may only be created and modified by code running in the Root world, from the Monitor code or Trusted Firmware).

In general, the protection check checks for which physical address spaces (PASs) are allowed for a particular physical address. In some cases, a simple table may indicate that, for the particular PA, any PAS is allowed, one or more PAS is allowed, or no PASs are allowed. While relatively simple tables 516 and 518 are shown, in some cases, a more complicated (e.g., multi-level and/or multi stage) table (or tables) may be used.

Referring again to table 516, in some cases another PAS such as the normal or non-secure (NS) PAS may be indicated that does not correspond to the world to which the transaction belongs. In other words, this may indicate an attempt to access a PA from another world corresponding to the other allowed PAS.

### Example Mixed Criticality Support

Certain aspects of the present disclosure provide mechanisms that may help support mixed criticality (transaction streams accessing PA ranges shared between worlds with different levels of criticality) using configurable access and translation regimes. To support mixed criticality, a translation regime for a SoC world may be selected to be managed by another world, such as the normal world. In addition, a type of access (e.g., read or write) to a PA range shared with the other world may be allowed or denied based on the SID and SoC world from which a transaction is issued.

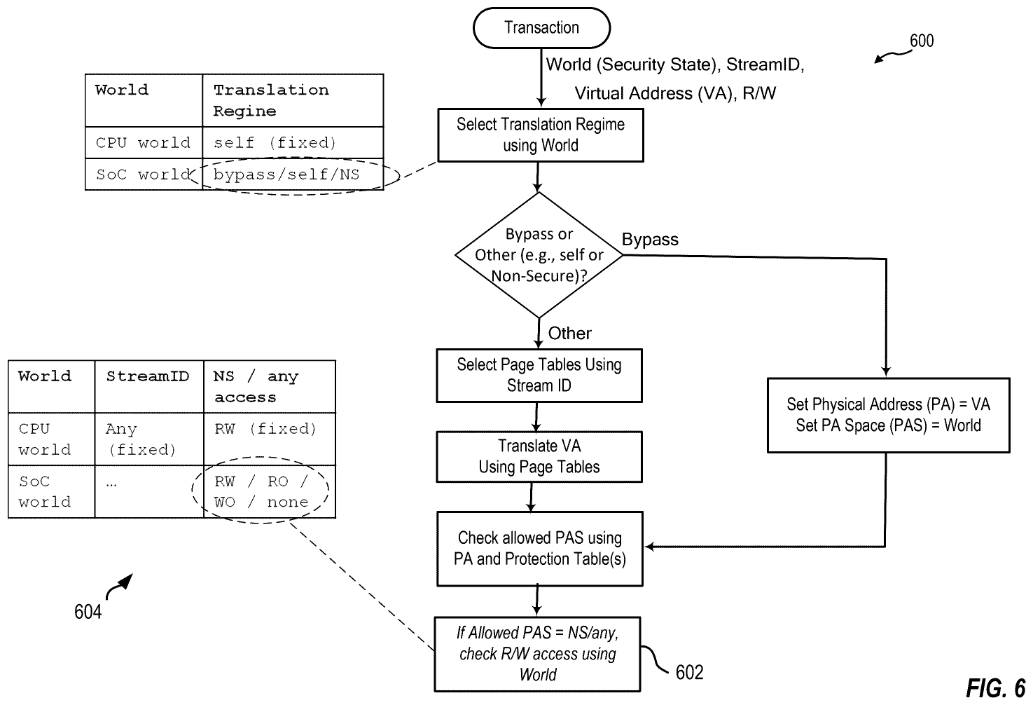

The mechanisms may be understood with reference to the flow diagram 600 of FIG. 6, that adds an additional translation regime option and an additional operation to the flow diagram 500 of FIG. 5.

As indicated at 602, if an allowed PAS (determined from table 518 in FIG. 5) is NS or any, the read/write access for the transaction may be checked using the World (e.g., the World ID provided with the transaction) and/or the StreamID (e.g., since different StreamIDs from the same World could have different access permissions).

As illustrated in table 604, the World ID may be used to access an access type. For an SoC World, the access may be Read, Write, Read and Write, or none (no access). This approach may allow for extra configuration options that can help support more use cases.

For example, rather than dedicating a whole SoC world to one particular use case, this approach allows different types of access to be specified. By controlling the type of access based on the World ID, different types of use cases may be accommodated, as needed.

As also illustrated in table 604, in some cases, the access type may also be dependent based on a StreamID. This may provide additional flexibility to configure access for particular SoC worlds and streams. In other words, different streams for the same SoC world could have different types of access to the same memory region.

This may help accommodate various different objectives, such as a DRM style use case where read only access may be configured in order to protect confidentiality (and prevent inadvertent writing). The memory may be allocated such that the protected content is in some generally accessible region.

Another option could be to indicate a specific location where content is to be read from. This may help when the integrity of content of interest is preserved. Another option is a use case that should be isolated the CPU, so the table may be configured such that no access (none) is given to any CPU worlds. Allowing this final access check to be configurable in this manner may help support a wide range of use cases.

In some use cases, it may be helpful to have metadata, describing certain aggregate characteristics of the secure data, to be visible to the non-secure world. For example, this may be the case where a sequence of images is processed and certain metadata (e.g., aggregate color, brightness, etc.) may be shared (e.g., to assist in processing subsequent images or frames) while still sufficiently protecting the confidentiality of the secure data.

The techniques may utilize certain types of extensions to support mixed criticality data streams in the manner proposed. Such extensions may help provide information indicating the different SoC world values (and/or different stream IDs) that have different permissions (e.g., for read and write access).

Different functional blocks or different hardware interfaces could generate different stream IDs. For example, a statistics block that generates a brightness histogram could generate a stream ID which is acceptable for writing to the non-secure world. On the other hand, video decode blocks may generate pixels, but the protected content may not be allowed to write (be written) to the non-secure world.

In this context, mixed criticality may refer to the notion of whether it is critical that certain content be protected from the non-secure world or not. For example, whether a workload is reading or writing pixels may be considered less critical than handling some sort of sensitive content or AI model weights may be considered valuable while other information may be considered less important (e.g., configuration data, statistics, or metadata).

A table that controls access, such as table 604 of FIG. 6, may be configured by a component that is considered trusted by SoC worlds, For example, such a table may be configured by an SoC world controller.

The mechanisms proposed herein may be used to advantage in a variety of use cases. For example, the mechanisms may be used in a digital rights management (DRM) scenario that involves protected content that is residing in memory, with a device that is trying to access the protected content. In such a case, a normal world (NS security state) may be used and translation tables may be managed so the protected content (which might be large image buffers and fragmented) may be accessed using mechanisms such as scatter-gather mechanisms from an MMU. If this translation is done by the Non-Secure world, but the non-secure world itself does not get access to those image buffers or the protected content. In other words, security may be maintained, in such cases, by not giving the NS world access to the contents. This approach may allow the image buffers to be fragmented in memory, providing greater flexibility without the need to carve out large continuous blocks in memory.

There are certain scenarios where the confidentiality of content may need to be protected without protecting the integrity. This may be the case if, for example, by managing these page tables, the non-secure word could direct the address translation to somewhere unintended (such that the protected content could become jumbled without losing confidentiality).

For other use cases, such as biometrics, jumbling of the content may be undesirable. In other words, integrity protection may be more important in the biometric use case. In such cases, the bypass translation regime may be used.

The mechanisms proposed herein allow the type of translation to be performed to be determined based on a world ID (e.g., which may indicate whether the transaction is coming from a device, rather than a CPU). This may provide some flexibility in achieving isolation from a set of entities (and from the CPU entirely).

The SoC world IDs may be indicated by values that cannot be generated by the CPU. For such IDs, the CPU may still manage page tables to do the address translation (even if it does not access the content itself).

### Example Support for Multiple Distrusting External Workloads

As noted above, one or more confidential processing domains or worlds under the processor control may coexist with more than one confidential processing domain or world controlled by more than one off-processor entity. In certain scenarios, multiple such off-processor entities may have external workloads that share resources in a secure computing environment. Aspects of the present disclosure may help support distrusted workloads associated with one or more off application (off-AP) processors.

Certain aspects of the present disclosure provide mechanisms that may help support mixed criticality (data/operations with different types of security states) using non-secure protected (NSP) regions. To support mixed criticality NSP, a type of memory access (e.g., read, write, read/write, or none) may be based on the world from which a transaction is issued (e.g., if a PAS allowed for a corresponding PA is a NS PAS).

### Example Method

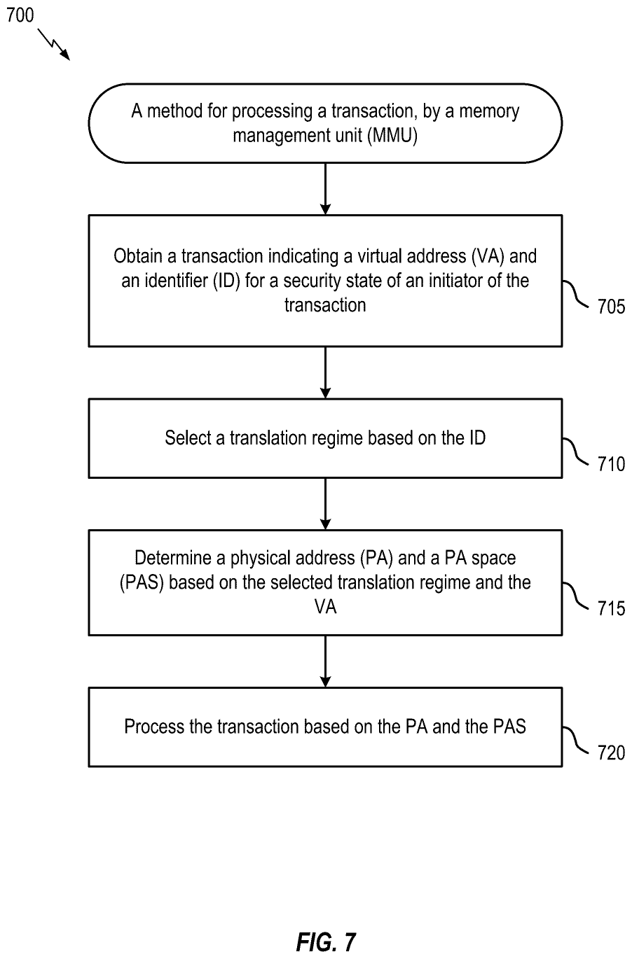

FIG. 7 shows an example of a method 700 of processing a transaction, by a memory management unit (MMU).

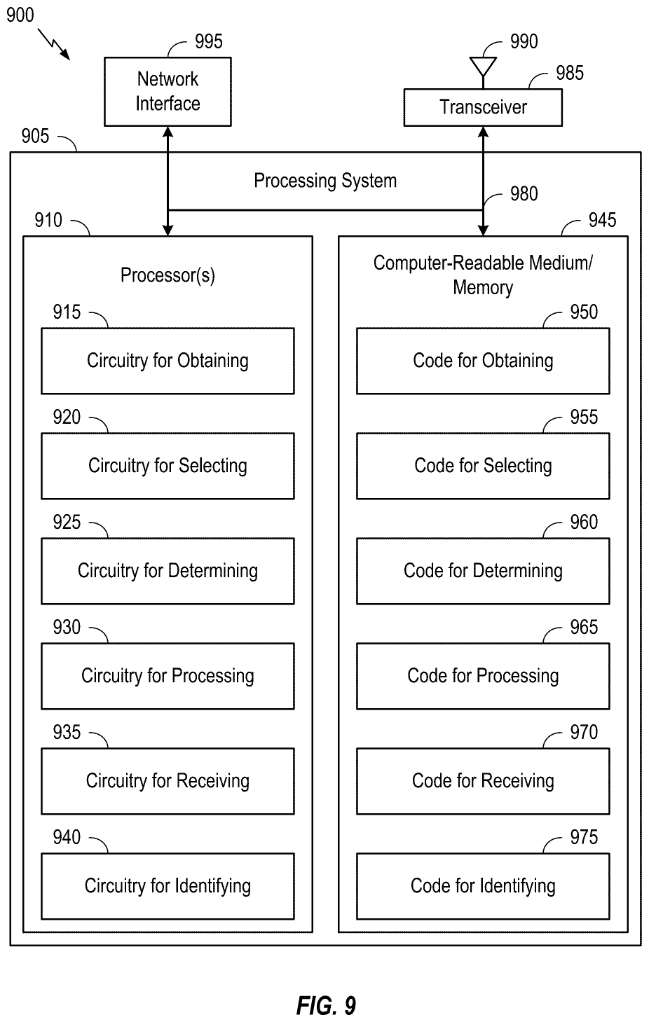

Method 700 begins at step 705 with obtaining a transaction indicating a virtual address (VA) and an identifier (ID) for a security state of an initiator of the transaction. In some cases, the operations of this step refer to, or may be performed by, circuitry for obtaining and/or code for obtaining as described with reference to FIG. 9.

Method 700 then proceeds to step 710 with selecting a translation regime based on the ID. In some cases, the operations of this step refer to, or may be performed by, circuitry for selecting and/or code for selecting as described with reference to FIG. 9.

Method 700 then proceeds to step 715 with determining a physical address (PA) and a PA space (PAS) based on the selected translation regime and the VA. In some cases, the operations of this step refer to, or may be performed by, circuitry for determining and/or code for determining as described with reference to FIG. 9.

Method 700 then proceeds to step 720 with processing the transaction based on the PA and the PAS. In some cases, the operations of this step refer to, or may be performed by, circuitry for processing and/or code for processing as described with reference to FIG. 9.

In some aspects, a first translation regime is selected if the ID for the security state indicates a system on a chip (SoC) security state; or a second translation regime is selected if the ID for the security state indicates a central processing unit (CPU) security state.

In some aspects, the selected translation regime comprises a bypass translation regime that determines the PA from the VA independent of page tables.

In some aspects, determining the PA and the PAS comprises: setting a value of the PA to a value of the VA; and setting a value of the PAS to a value of the ID.

In some aspects, the selected translation regime comprises a non-secure (NS) translation regime or a self-translation regime.

In some aspects, determining the PA and the PAS comprises: translating the VA to the PA using one or more page tables.

In some aspects, the transaction further indicates a stream ID (SID), and determining the PA and the PAS comprises selecting the one or more page tables based on the SID.

In some aspects, selecting the translation regime comprises selecting a bypass translation regime, or a self-translation regime from a table.

In some aspects, the table is configurable to allow the MMU to select between translation for central processing unit (CPU) worlds and system-on-a-chip (SoC) worlds.

In some aspects, selecting the translation regime comprises selecting the bypass translation regime when the ID indicates an SoC world.

In some aspects, the ID for the security state indicates a system on a chip (SoC) security state.

In one aspect, method 700, or any aspect related to it, may be performed by an apparatus, such as device 900 of FIG. 9, which includes various components operable, configured, or adapted to perform the method 700. Device 900 is described below in further detail.

Note that FIG. 7 is just one example of a method, and other methods including fewer, additional, or alternative steps are possible consistent with this disclosure.

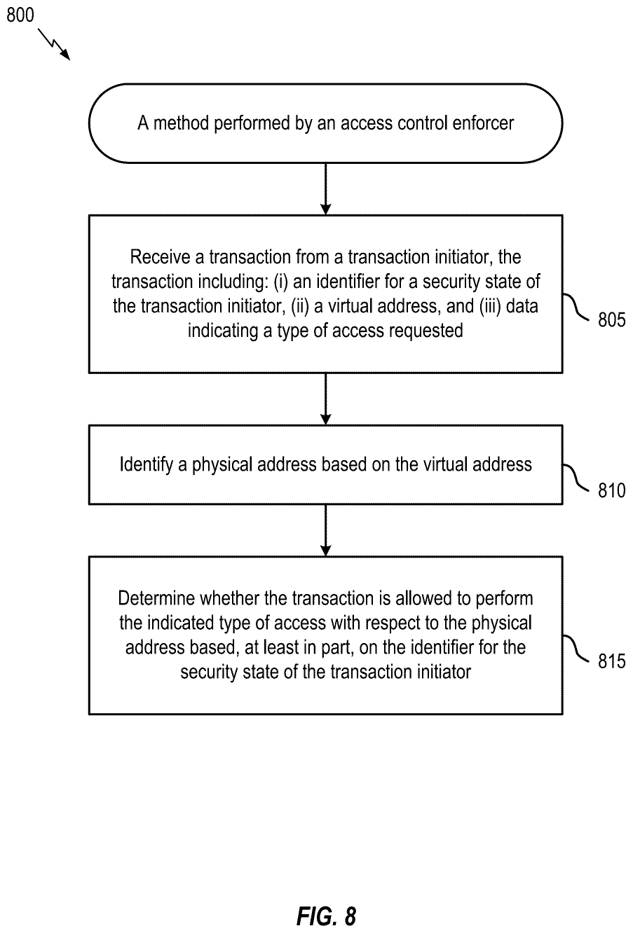

FIG. 8 shows an example of a method 800 by an access control enforcer.

Method 800 begins at step 805 with receiving a transaction from a transaction initiator, the transaction including: (i) an identifier for a security state of the transaction initiator, (ii) a virtual address, and (iii) data indicating a type of access requested. In some cases, the operations of this step refer to, or may be performed by, circuitry for receiving and/or code for receiving as described with reference to FIG. 9.

Method 800 then proceeds to step 810 with identifying a physical address based on the virtual address. In some cases, the operations of this step refer to, or may be performed by, circuitry for identifying and/or code for identifying as described with reference to FIG. 9.

Method 800 then proceeds to step 815 with determining whether the transaction is allowed to perform the indicated type of access with respect to the physical address based, at least in part, on the identifier for the security state of the transaction initiator. In some cases, the operations of this step refer to, or may be performed by, circuitry for determining and/or code for determining as described with reference to FIG. 9.

In some aspects, the method 800 further includes identifying a physical address space (PAS) based on the virtual address. In some cases, the operations of this step refer to, or may be performed by, circuitry for identifying and/or code for identifying as described with reference to FIG. 9.

In some aspects, the method 800 further includes determining whether the transaction is allowed to perform the indicated type of access for the physical address using at least one table and the PAS. In some cases, the operations of this step refer to, or may be performed by, circuitry for determining and/or code for determining as described with reference to FIG. 9.

In some aspects, the at least one table indicates that the physical address is associated with at least one PAS; and the determining is based on the at least one table indicating the physical address is associated with the at least one PAS.

In some aspects, the at least one PAS comprises a non-secure PAS.

In some aspects, the transaction includes a stream identifier; and the determining is also based on the stream identifier.

In some aspects, the at least one table comprises a first table and a second table; the first table indicates that the physical address is associated with the at least one PAS; and the second table indicates a type of access permitted for the physical address associated with the at least one PAS.

In some aspects, the determining comprises comparing the type of access being requested for the physical address to the type of access that is permitted for the physical address.

In some aspects, the type of access indicated in the second table includes read access and write access, read access only, write access only, or no read access and no write access.

In some aspects, the method 800 further includes selecting a translation regime using the identifier for the security state of the transaction initiator. In some cases, the operations of this step refer to, or may be performed by, circuitry for selecting and/or code for selecting as described with reference to FIG. 9.

In some aspects, the method 800 further includes identifying the physical address based on the virtual address and the selected translation regime. In some cases, the operations of this step refer to, or may be performed by, circuitry for identifying and/or code for identifying as described with reference to FIG. 9.

In some aspects, the selected translation regime indicates that the virtual address does not need to be translated; and identifying the physical address based on the virtual address and the selected translation regime comprises setting the physical address to the virtual address.

In some aspects, the transaction includes a stream identifier; the selected translation regime indicates that the virtual address needs to be translated; and the method further comprises: selecting one or more page tables using the stream identifier; and the identifying comprises translating the virtual address to the physical address using the one or more page tables.

In some aspects, the determining is based on a table that indicates an access attribute, wherein the access attribute comprises at least one of: read and write access, read only access, write only access, or no read or write access.

In some aspects, the table indicates the access attribute based on the identifier for the security state of the transaction initiator and a stream identifier indicated by the transaction.

In one aspect, method 800, or any aspect related to it, may be performed by an apparatus, such as device 900 of FIG. 9, which includes various components operable, configured, or adapted to perform the method 800. Device 900 is described below in further detail.

Note that FIG. 8 is just one example of a method, and other methods including fewer, additional, or alternative steps are possible consistent with this disclosure.

### Example Device

FIG. 9 depicts aspects of an example device 900.

The device 900 includes a processing system 905 coupled to the transceiver 985 (e.g., a transmitter and/or a receiver) and/or a network interface 995. The transceiver 985 is configured to transmit and receive signals for the device 900 via the antenna 990, such as the various signals as described herein. The network interface 995 is configured to obtain and send signals for the device 900 via communication link(s), such as a backhaul link, midhaul link, and/or fronthaul link. The processing system 905 may be configured to perform processing functions for the device 900, including processing signals received and/or to be transmitted by the device 900.

The processing system 905 includes one or more processors 910. The one or more processors 910 are coupled to a computer-readable medium/memory 945 via a bus 980. In certain aspects, the computer-readable medium/memory 945 is configured to store instructions (e.g., computer-executable code) that when executed by the one or more processors 910, cause the one or more processors 910 to perform the method 700 described with respect to FIG. 7, or any aspect related to it; and the method 800 described with respect to FIG. 8, or any aspect related to it. Note that reference to a processor of device 900 performing a function may include one or more processors 910 of device 900 performing that function.

In the depicted example, the computer-readable medium/memory 945 stores code (e.g., executable instructions), such as code for obtaining 950, code for selecting 955, code for determining 960, code for processing 965, code for receiving 970, and code for identifying 975. Processing of the code for obtaining 950, code for selecting 955, code for determining 960, code for processing 965, code for receiving 970, and code for identifying 975 may cause the device 900 to perform the method 700 described with respect to FIG. 7, or any aspect related to it; and the method 800 described with respect to FIG. 8, or any aspect related to it.

The one or more processors 910 include circuitry configured to implement (e.g., execute) the code stored in the computer-readable medium/memory 945, including circuitry such as circuitry for obtaining 915, circuitry for selecting 920, circuitry for determining 925, circuitry for processing 930, circuitry for receiving 935, and circuitry for identifying 940. Processing with circuitry for obtaining 915, circuitry for selecting 920, circuitry for determining 925, circuitry for processing 930, circuitry for receiving 935, and circuitry for identifying 940 may cause the device 900 to perform the method 700 described with respect to FIG. 7, or any aspect related to it; and the method 800 described with respect to FIG. 8, or any aspect related to it.

Various components of the device 900 may provide means for performing the method 700 described with respect to FIG. 7, or any aspect related to it; and the method 800 described with respect to FIG. 8, or any aspect related to it.

### Example Clauses

Implementation examples are described in the following numbered clauses:

Clause 1: A method for processing a transaction, by a memory management unit (MMU), comprising: obtaining a transaction indicating a virtual address (VA) and an identifier (ID) for a security state of an initiator of the transaction; selecting a translation regime based on the ID; determining a physical address (PA) and a PA space (PAS) based on the selected translation regime and the VA; and processing the transaction based on the PA and the PAS.

Clause 2: The method of Clause 1, wherein: a first translation regime is selected if the ID for the security state indicates a system on a chip (SoC) security state; or a second translation regime is selected if the ID for the security state indicates a central processing unit (CPU) security state.

Clause 3: The method of Clause 2, wherein: the selected translation regime comprises a bypass translation regime that determines the PA from the VA independent of page tables.

Clause 4: The method of Clause 3, wherein determining the PA and the PAS comprises: setting a value of the PA to a value of the VA; and setting a value of the PAS to a value of the ID.

Clause 5: The method of Clause 3, wherein: the selected translation regime comprises a non-secure (NS) translation regime or a self-translation regime.

Clause 6: The method of Clause 5, wherein determining the PA and the PAS comprises: translating the VA to the PA using one or more page tables.

Clause 7: The method of Clause 6, wherein: the transaction further indicates a stream ID (SID), and determining the PA and the PAS comprises selecting the one or more page tables based on the SID.

Clause 8: The method of any one of Clauses 1-7, wherein selecting the translation regime comprises selecting a bypass translation regime, or a self-translation regime from a table.

Clause 9: The method of Clause 8, wherein the table is configurable to allow the MMU to select between translation for central processing unit (CPU) worlds and system-on-a-chip (SoC) worlds.

Clause 10: The method of Clause 9, wherein selecting the translation regime comprises selecting the bypass translation regime when the ID indicates an SoC world.

Clause 11: The method of any one of Clauses 1-10, wherein the ID for the security state indicates a system on a chip (SoC) security state.

Clause 12: An apparatus, comprising: at least one memory comprising executable instructions; and at least one processor configured to execute the executable instructions and cause the apparatus to perform a method in accordance with any combination of Clauses 1-11.

Clause 13: An apparatus, comprising means for performing a method in accordance with any combination of Clauses 1-11.

Clause 14: A non-transitory computer-readable medium comprising executable instructions that, when executed by at least one processor of an apparatus, cause the apparatus to perform a method in accordance with any combination of Clauses 1-11.

Clause 15: A computer program product embodied on a computer-readable storage medium comprising code for performing a method in accordance with any combination of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

Means for obtaining, means for selecting, means for determining, means for processing, means for receiving, and means for identifying may comprise one or more processors, such as one or more of the processors described above with reference to FIG. 9.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for processing a transaction, by a memory management unit (MMU), comprising:
obtaining a transaction indicating a virtual address (VA) and an identifier (ID) for a security state of an initiator of the transaction;
selecting a translation regime based on the ID;
determining a physical address (PA) and a PA space (PAS) based on the selected translation regime and the VA; and
processing the transaction based on the PA and the PAS.

2. The method of claim 1, wherein:
a first translation regime is selected if the ID for the security state indicates a system on a chip (SoC) security state; or
a second translation regime is selected if the ID for the security state indicates a central processing unit (CPU) security state.

3. The method of claim 2, wherein:
the selected translation regime comprises a bypass translation regime that determines the PA from the VA independent of page tables.

4. The method of claim 3, wherein determining the PA and the PAS comprises:
setting a value of the PA to a value of the VA; and
setting a value of the PAS to a value of the ID.

5. The method of claim 3, wherein:
the selected translation regime comprises a non-secure (NS) translation regime or a self-translation regime.

6. The method of claim 5, wherein determining the PA and the PAS comprises:
translating the VA to the PA using one or more page tables.

7. The method of claim 6, wherein:
the transaction further indicates a stream ID (SID), and
determining the PA and the PAS comprises selecting the one or more page tables based on the SID.

8. The method of claim 1, wherein selecting the translation regime comprises selecting a bypass translation regime, or a self-translation regime from a table.

9. The method of claim 8, wherein the table is configurable to allow the MMU to select between translation for central processing unit (CPU) worlds and system-on-a-chip (SoC) worlds.

10. The method of claim 9, wherein selecting the translation regime comprises selecting the bypass translation regime when the ID indicates an SoC world.

11. The method of claim 1, wherein the ID for the security state indicates a system on a chip (SoC) security state.

12. An apparatus, comprising:
at least one memory comprising instructions; and
at least one processor configured to execute the instructions and cause the apparatus to:
obtain a transaction indicating a virtual address (VA) and an identifier (ID) for a security state of an initiator of the transaction;
select a translation regime based on the ID;
determine a physical address (PA) and a PA space (PAS) based on the selected translation regime and the VA; and
process the transaction based on the PA and the PAS.

13. The apparatus of claim 12, wherein:
a first translation regime is selected if the ID for the security state indicates a system on a chip (SoC) security state; or
a second translation regime is selected if the ID for the security state indicates a central processing unit (CPU) security state.

14. The apparatus of claim 13, wherein:
the selected translation regime comprises a bypass translation regime that determines the PA from the VA independent of page tables.

15. The apparatus of claim 14, wherein determining the PA and the PAS comprises:
setting a value of the PA to a value of the VA; and
setting a value of the PAS to a value of the ID.

16. The apparatus of claim 14, wherein:
the selected translation regime comprises a non-secure (NS) translation regime or a self-translation regime.

17. The apparatus of claim 16, wherein determining the PA and the PAS comprises:
translating the VA to the PA using one or more page tables.

18. The apparatus of claim 17, wherein:
the transaction further indicates a stream ID (SID), and
determining the PA and the PAS comprises selecting the one or more page tables based on the SID.

19. The apparatus of claim 12, wherein selecting the translation regime comprises selecting a bypass translation regime, or a self-translation regime from a table.

20. A non-transitory computer-readable medium comprising instructions that, when executed by at least one processor, cause the at least one processor to perform a method, obtaining a transaction indicating a virtual address (VA) and an identifier (ID) for a security state of an initiator of the transaction;
selecting a translation regime based on the ID;
determining a physical address (PA) and a PA space (PAS) based on the selected translation regime and the VA; and
processing the transaction based on the PA and the PAS.
